(19) United States
(12) Patent Application Publication
(10) Pub. No.: US 2023/0151730 A1
(43) Pub. Date: May 18, 2023

(54) METHOD AND DEVICE FOR STUDYING FLUID EQUILIBRIUM DISTRIBUTION IN HETEROGENEOUS OIL AND GAS RESERVOIRS

(71) Applicant: Southwest Petroleum University, Chengdu City (CN)

(72) Inventors: Xiaolong PENG, Chengdu City (CN); Chaowen WANG, Chengdu City (CN); Suyang ZHU, Chengdu City (CN); Peng DENG, Chengdu City (CN); Chunsheng JIA, Chengdu City (CN); Dong FEI, Chengdu City (CN); Haoqiang WU, Chengdu City (CN); Yi XU, Chengdu City (CN); Si ZHANG, Chengdu City (CN); Zeyu YE, Chengdu City (CN)

(21) Appl. No.: 17/892,153

(22) Filed: Aug. 22, 2022

(30) Foreign Application Priority Data
Nov. 11, 2021 (CN) 202111331332.4

(51) Int. Cl. E21B 49/00; G06F 30/28

(52) U.S. Cl. CPC E21B 49/00; G06F 30/28; G06F 2111/10

(57) ABSTRACT

The present invention discloses a method and device for studying fluid equilibrium distribution in heterogeneous oil and gas reservoirs. Firstly, a reservoir is divided into multiple layers according to permeability of the reservoir; a pressure-depth curve of formation water in surrounding rock is established; the pressure-depth curve of a non-wetting phase is made by passing through a point in the reservoir and taking a product of density and acceleration of gravity of the non-wetting phase as a slope; the pressure-depth curve of displacement pressure of the reservoir is added on the basis of the pressure-depth curve of the formation water; and the pressure-depth curve of the non-wetting phase is repeatedly compared with the pressure-depth curve of the displacement pressure to obtain static equilibrium distribution of fluid in the reservoir.

### FIELD OF THE INVENTION

The present invention relates to the field of exploration for oil and gas reservoirs, and more particularly to a method and device for studying fluid equilibrium distribution in heterogeneous oil and gas reservoirs.

### BACKGROUND OF THE INVENTION

Determination of the fluid equilibrium distribution of oil and gas reservoirs in an original state is a basis for establishing a geological model and a flow model, and is a basis for calculating reserves, defining fluid distribution, establishing initial conditions for oil reservoir numerical simulation, recognizing water mechanism or source and establishing fluid production profiles. It has an important influence on the percolation field and residual oil and gas distribution of oil and gas reservoirs, and provides a data basis for dynamic analysis and yield prediction of oil and gas reservoirs.

For lithologically homogeneous oil and gas reservoirs, under the state of static equilibrium, gas, oil and water are distributed from top to bottom, with a gas-oil transition zone and an oil-water transition zone in the middle, and the length of the transition zones is controlled by capillary forces. However, for lithologically heterogeneous oil and gas reservoirs, the distribution of oil, gas and water is very complex. For the same layer, due to the difference of reservoirs in different positions, the capillary force difference is different, resulting in the tilt and fluctuation of a gas-water interface. For multi-layer oil and gas reservoirs, the static equilibrium of oil, gas and water will generate phenomena of alternation and inversion. Under the condition of known oil-water interface and gas-water interface, the existing vertical equilibrium distribution model of fluid can be used to determine the fluid distribution of the oil and gas reservoirs under the equilibrium state.

For example, the following methods are usually used in the prior art to determine the fluid distribution of the oil and gas reservoirs in the original state: vertical equilibrium calculation, which determines fluid saturation distribution through oil, gas and water interfaces (an oil-water interface, a gas-oil interface or a gas-water interface) and capillary force curves, and finally determines the equilibrium distribution of the fluid.

However, it is difficult to determine the static equilibrium distribution of the fluid under the existing technical conditions when the oil-water interface or gas-water interface of some oil and gas reservoirs may not exist, is unclear or is difficult to determine.

### SUMMARY OF THE INVENTION

In view of the above technical problems, one purpose of the present invention is to provide a method for studying fluid equilibrium distribution in heterogeneous oil and gas reservoirs with respect to the defects of the prior art, which can determine static fluid equilibrium distribution in heterogeneous oil reservoirs without a determined fluid interface.

To achieve the above technical purpose, the present invention adopts the following technical solution: a method for studying fluid equilibrium distribution in heterogeneous oil and gas reservoirs comprises the following steps:

step S1: dividing an overall reservoir into M layers from top to bottom longitudinally according to displacement pressure and permeability, wherein for adjacent reservoirs a and b, a,b∈(1,..., M) ;

$${P}_{c d}^{a} ⩾ 1.5 {P}_{c d}^{b}$$

needs to be satisfied;

$${k}^{a} ⩾ 2 {k}^{b}$$

, where

$${P}_{c d}^{a}$$

is displacement pressure of the reservoir a,

$${P}_{c d}^{b}$$

is displacement pressure of the reservoir b, k^{a} is permeability of the reservoir a and k^{b}is permeability of the reservoir b;

step S2: establishing a pressure-depth curve ^{l}_{pw} : p_{w} (D) = p_{wref} + ρ_{w}g(D-D_{ref}) according to a pressure-depth relationship of formation water in surrounding rock, where ρᵥ is density of a wetting phase of the surrounding rock; g is gravity acceleration; D is reservoir depth; and p_{wref} is pressure of a reference point;

step S3: taking a point A on a reservoir i , where i ∈ {1,..., M} ; making a straight line lₚₘ : pₙ (D) = p_{nA}+ ρₙg(D-D_{A}) with both ends passing through a rock layer i through the point, where ρₙ is density of a non-wetting phase n in surrounding rock; Z_{A} is the depth of the point A; and P_{nA} is pressure of the point A;

step S4: according to the pressure-depth curve and the displacement pressure of the reservoir i , establishing a straight line

$${l}_{p d}^{i} : {p}_{w} \left(D\right) + {p}_{c d}^{i} ∼ D {}_{,}$$

where

$${p}_{c d}^{i} \text{v}$$

is the displacement pressure of the reservoir i , and according to whether the straight line lₚₙ and the straight line

$${l}_{p d}^{i}$$

intersect in the reservoir i and the pressure size, judging the distribution of the non-wetting phase n in the reservoir :

when the straight line lₚₙ and the straight line

$${l}_{p d}^{i}$$

intersect in the reservoir i , an intersection point therebetween is a junction point of the non-wetting phase n and the wetting phase;

when the straight line

$${l}_{p n}$$

and the straight line

$${l}_{p d}^{i}$$

do not intersect in the reservoir i , and

$${p}_{n}^{i} > {p}_{w}^{i} + {p}_{c d}^{i} {}_{,}$$

the non-wetting phase n is continuously distributed in the reservoir i , where

$${p}_{n}^{i}$$

is the value of the straight line lₚₙin the reservoir i ; and

$${p}_{w}^{i}$$

is the value of the straight line l_{pw} in the reservoir i ;

when the straight line lₚₙ and the straight line

$${l}_{p d}^{i}$$

do not intersect in the reservoir i , and

$${p}_{n}^{i} < {p}_{w}^{i} + {p}_{c d}^{i} {}_{,}$$

the continuously distributed non-wetting phase ndoes not exist in the reservoir i ;

step S5: when the non-wetting phase n is continuously distributed in the reservoir i , establishing a straight line

$${l}_{p d}^{i \text{-} l} : \left[{p}_{\text{w}} \left(\text{D}\right) + {p}_{c d}^{i - 1}\right] ∼ D {}_{,}$$

, where

$${p}_{c d}^{i \text{-} 1}$$

is the displacement pressure in a reservoir i - 1 and the reservoir i - 1 is located above the reservoir i , and according to whether the straight line lₚₙ and the straight line

$${l}_{p d}^{i \text{-} 1}$$

intersect in the reservoir i * ^{,} - 1 and the pressure size, judging the distribution of the non-wetting phase n in the reservoir i - 1 :

when the straight line lₚₙ and the straight line

$${l}_{p d}^{i \text{-} 1}$$

do not intersect in the reservoir i - 1 ,

$${p}_{\text{n}}^{\text{i} - 1} > {p}_{\text{w}}^{i - 1} + {p}_{c d}^{i - 1} {}_{,}$$

where

$${P}_{n}^{i - 1}$$

is the value of the straight line lₚₙ in the reservoir i - 1 ; and

$${P}_{w}^{i - 1}$$

is the value of the straight line l_{pw} in the reservoir i - 1 ; the non-wetting phase n is continuously distributed in the reservoir i - 1 and i = i - 1 is made; step S5 is repeated; otherwise, the continuously distributed non-wetting phase does not exist in the reservoir i - 1 ;

step S6: when the non-wetting phase is continuously distributed in the reservoir i or a junction point of the non-wetting phase and the wetting phase exists, establishing a straight line

$${l}_{p d}^{i + 1} : {p}_{w} \left(D\right) + {p}_{c d}^{i + 1} \sim D ,$$

where

$${p}_{c d}^{i + 1}$$

is the displacement pressure in a reservoir i + 1 and the reservoir i + 1 is located below the reservoir i , and according to whether the straight line and the straight line

$${l}_{p d}^{i - 1}$$

intersect in the reservoir i + 1 and the pressure size, judging the distribution of the non-wetting phase n in the reservoir i + 1:

when the straight line lₚₙ ₙ and the straight line

$${l}_{p d}^{i + 1}$$

do not intersect in the reservoir i + 1, and

$${p}_{n}^{i + 1} > {p}_{w}^{i + 1} + {p}_{c d}^{i + 1} ,$$

the non-wetting phase n is continuously distributed in the reservoir i + 1 , and i = i + 1 is made; step S6 is repeated; otherwise, the following determination is conducted:

if the straight line lₚₙ and the straight line

$${l}_{p d}^{i + 1}$$

intersect in the reservoir i + 1, the intersection point is the junction point of the non-wetting phase and the wetting phase; under such conditions, when

$${\text{p}}_{\text{cd}}^{\text{i} + 2} \geq {p}_{c d}^{i + 1} ,$$

where

$${\text{p}}_{\text{cd}}^{\text{i} + 2}$$

is the displacement pressure of a reservoir i + 2 , then the reservoir i + 2 is a pure wetting phase; i = i + 1 is made; and the sizes of

$${p}_{d}^{i + 1}$$

and

$${p}_{d}^{i + 2}$$

are determined continuously until the condition is not satisfied or i + 1 = M;

step S7: for a point B in the same reservoir and in a region adjacent to a region where the point A is located, if a region where the point B is located and the region where the point A is located are in the same continuous distribution region of the non-wetting phase n, the calculation of the region where the point B is located is the same as the step of the region where the point A is located; if the region where the point B is located and the region where the point A is located are in different continuous distribution regions of the non-wetting phase n, repeating steps S3-S6 with the point B as a benchmark.

Another purpose of the present invention is to provide a device for studying fluid equilibrium distribution in heterogeneous oil and gas reservoirs, comprising:
a processor, and
an acquisition module, used for acquiring initial data for studying fluid equilibrium distribution in heterogeneous oil and gas reservoirs;
an output module, used for outputting calculation results;
a memory, wherein the memory stores programs that can be run on the processor for studying the fluid equilibrium distribution in heterogeneous oil and gas reservoirs, and the programs for studying the fluid equilibrium distribution in heterogeneous oil and gas reservoirs realize the steps of the above method when executed by the processor.

Another purpose of the present invention is to provide a computer readable storage medium. The computer readable storage medium stores program codes that can be executed by the processor; the computer readable storage medium comprises a plurality of instructions, and the plurality of instructions are configured to enable the processor to execute the above method for studying fluid equilibrium distribution in heterogeneous oil and gas reservoirs.

The present invention has the following beneficial effects:
(1) Compared with the traditional vertical equilibrium distribution model of fluid, the present invention does not need oil, gas and water interfaces.
(2) Compared with end-point correction of the capillary force and relative permeability adopted by oil reservoir numerical simulation software such as ECLIPSE, the present invention can correct the capillary force curve entirely.
(3) Heterogeneous oil and gas reservoirs of transverse and vertical reservoirs can be processed.
(4) Through the method of the present invention, if the distribution of the fluid at a certain position in the reservoir and the pressure of the fluid in each phase are known, the capillary force curve can be corrected.

### BRIEF DESCRIPTION OF THE DRAWINGS

FIG. 1 is a structural schematic diagram of a device for studying fluid equilibrium distribution in heterogeneous oil and gas reservoirs in embodiment 1.

### DETAILED DESCRIPTION OF PREFERRED EMBODIMENTS

To make the technical solutions and technical advantages of the present invention more clear, the technical solutions in the implementation process of the present invention will be clearly and fully described below in combination with the embodiments.

In the following embodiments, the wetting phase is a water phase and the non-wetting phase is an oil phase or gas phase.

### Embodiment 1

A method for studying fluid equilibrium distribution in heterogeneous oil and gas reservoirs comprises the following steps:
Step S1: dividing an overall reservoir into M layers from top to bottom longitudinally according to displacement pressure and permeability, wherein for adjacent reservoirs a and b, a,b∈(1,...,M);
$${P}_{c d}^{a} ⩾ 1.5 {P}_{c d}^{b}$$
needs to be satisfied;
$${k}^{a} ⩾ 2 {k}^{b}$$
, where
$${P}_{c d}^{a}$$
is displacement pressure of the reservoir a,
$${P}_{c d}^{a}$$
is displacement pressure of the reservoir b, k^{a} is permeability k^{b} of the reservoir a and is permeability of the reservoir b.
Step S2: establishing a pressure-depth curve l_{pw} : p_{w}(D)=p_{wref} + ρ_{w}g(D-D_{ref}) according to a pressure-depth relationship of formation water in surrounding rock, where ρ_{w} is density of a wetting phase of the surrounding rock; g is gravity acceleration; D is reservoir depth; P_{wref} is pressure of a reference point; and D_{ref} is depth of the reference point.
   In the present embodiment, it is considered that the sealing property of surrounding rock prevents oil and gas from entering the surrounding rock due to the action of the capillary force. However, formation water, as a wetting phase, can enter the surrounding rock, and thus in the original state of the oil and gas reservoirs, the pressure-depth curve in the surrounding rock is the same as the pressure-depth curve of groundwater in a formation where the oil and gas reservoirs are located. Therefore, the established pressure-depth curve l_{pw} is equivalent to the pressure-depth curve of the groundwater in the formation where the oil and gas reservoirs are located.
Step S3: taking a point A on a reservoir i , where i ∈ {1,..., M} ; making a straight line lₚₙ : pₙ(D) = p_{nA} + ρₙg(D-D_{A}) with both ends passing through a rock layer i through the point, where ρₙ is density of a non-wetting phase n in surrounding rock; Z_{A} is the depth of the point A; and P_{nA} is pressure of the point A.
   In the present embodiment, the reservoir i is a main production layer, and the main production layer can be determined according to various data (data of earthquake, drilling, logging and well testing), which belongs to the prior art in the field.
Step S4: firstly, determining whether the reservoir i comprises a fluid interface: according to the pressure-depth curve and the displacement pressure of the reservoir i , establishing a straight line
$${l}_{p d}^{i} : \left[{p}_{w} \left(D\right) + {p}_{c d}^{i}\right] \sim D ,$$
where
$${P}_{d}^{i}$$
is the displacement pressure of the reservoir i , and according to whether the straight line lₚₙ and the straight line
$${l}_{p d}^{i}$$
intersect in the reservoir i and the pressure size, judging the distribution of the non-wetting phase n in the reservoir i .

In the present embodiment, the displacement pressure

$${p}_{c d}^{i}$$

of the reservoir i is determined according to a capillary force curve

$${p}_{c}^{i} \left({S}_{w}\right) \sim {S}_{w} ,$$

and the displacement pressure can also be determined by other methods.

When the straight line lₚₙ and the straight line

$${l}_{p d}^{i}$$

intersect in the reservoir i , an intersection point therebetween is a junction point of the non-wetting phase n and the wetting phase.

When the straight line lₚₙ and the straight line

$${l}_{p d}^{i}$$

do not intersect in the reservoir i , and

$${p}_{n}^{i} > {P}_{w}^{i} + {p}_{c d}^{i} ,$$

the non-wetting phase n is continuously distributed in the reservoir i , where

$${p}_{\text{n}}^{i}$$

is the value of the straight line lₚₙ in the reservoir i ; and

$${P}_{w}^{i}$$

is the value of the straight line l_{pw} in the reservoir i . In the present invention,

$${p}_{n}^{i} > {p}_{w}^{i} + {p}_{c d}^{i}$$

means that in the reservoir i , when the depth D of the reservoir is identical, the value of

$${P}_{n}^{i}$$

n is larger than the value of

$${p}_{w}^{i} + {p}_{c d}^{i} .$$

When the straight line lₚₙ and the straight line

$${l}_{p d}^{i}$$

do not intersect in the reservoir i , and

$${p}_{n}^{i} < {p}_{w}^{i} + {p}_{c d}^{i} ,$$

the continuously distributed non-wetting phase n does not exist in the reservoir i ; step S3 is returned; and a new point is selected from the reservoir again for measurement and calculation. In the present invention,

$${p}_{n}^{i} < {p}_{w}^{i} + {p}_{c d}^{i}$$

means that in the reservoir i , when the depth D of the reservoir is identical, the value of

$${p}_{\text{n}}^{i}$$

is less than the value of

$${p}_{w}^{i} + {p}_{c d}^{i} .$$

Step S5: when the non-wetting phase n is continuously distributed in the reservoir i , establishing a straight line

$${l}_{p d}^{i - 1} : {p}_{w} \left(D\right) + {p}_{c d}^{i - 1} \sim D ,$$

where

$${p}_{c d}^{i - 1}$$

is the displacement pressure in a reservoir i - 1 and the reservoir i - 1 is located above the reservoir i , and according to whether the straight line lₚₙ and the straight line

$${l}_{p d}^{i - 1}$$

intersect in the reservoir i - 1 and the pressure size, judging the distribution of the non-wetting phase n in the reservoir i - 1:

When the straight line lₚₙ and the straight line

$${l}_{p d}^{i}$$

do not intersect in the reservoir i - 1, and

$${p}_{n}^{i - 1} > {p}_{w}^{i - 1} + {p}_{c d}^{i - 1} ,$$

where

$${p}_{n}^{i - 1}$$

is the value of the straight line lₚₙ in the reservoir i - 1 and

$${p}_{w}^{i - 1}$$

is the value of the straight line l_{pw} in the reservoir i - 1 , the non-wetting phase n is continuously distributed in the reservoir i - 1 and i = i - 1: is made; and step S5 is repeated. In the present invention,

$${p}_{n}^{i - 1} > {p}_{w}^{i - 1} + {p}_{c d}^{i - 1}$$

means that in the reservoir i - 1, when the depth D of the reservoir is identical, the value of

$${p}_{n}^{i - 1}$$

is larger than the value of

$${p}_{w}^{i - 1} + {p}_{c d}^{i - 1} .$$

When the straight line lₚₙ and the straight line

$${l}_{p d}^{i - 1}$$

intersect in the reservoir i - 1, the fluid interface of the non-wetting phase n in the reservoir i - 1 penetrates through the intersection point and the continuously distributed non-wetting phase n does not exist in the reservoir i - 1.

In particular, although continuous distribution regions of the non-wetting phase n may appear in different reservoirs, these regions may be communicated with each other, for example, communicated through cracks, and may also be disconnected, i.e., two continuous distribution regions are uncorrelated. Therefore, when the continuous distribution region of the non-wetting phase n appears in an upper reservoir i - 1 - m ( (i - 1 - m)∈{1,..., M} and m > 0) of the fluid interface, judgment needs to be made about whether the region which appears in the reservoir i - 1 - m and the point A are in the same continuous distribution region of the non-wetting phase n through the capillary force curve and the reservoir pressure; if so, a straight line

$${l}_{p d}^{i - 1 - m}$$

is established by the method in step S5 and is compared with the straight line lₚₙ by the method in step S5; if not, a new pressure-depth curve needs to be established again in the reservoir ^{i-l-m} and measurement is continued according to the method in step S2 and subsequent steps.

Step S6: determining the equilibrium distribution of fluid in a downward reservoir of the reservoir i: when the non-wetting phase in the reservoir i is continuously distributed or a junction point of the non-wetting phase and the wetting phase exists, establishing a straight line

$${l}_{p d}^{i + 1} : \left[{p}_{w} \left(D\right) + {p}_{c d}^{i + 1}\right] \sim D ,$$

where

$${p}_{c d}^{i + 1}$$

is the displacement pressure in a reservoir i+1 and the reservoir i+1 is located below the reservoir i, and according to whether the straight line lₚₙ and the straight line

$${l}_{p d}^{i - 1}$$

intersect in the reservoir i+1 and the pressure size, judging the distribution of the non-wetting phase n in the reservoir i+1:

When the straight line lₚₙ and the straight line

$${l}_{p d}^{i + 1}$$

do not intersect in the reservoir i+1, and

$${p}_{n}^{i + 1} > {p}_{w}^{i + 1} + {p}_{c d}^{i + 1} ,$$

, the non-wetting phase n is continuously distributed in the reservoir i+1; i=i+1 is made; and step S6 is repeated. In the present invention,

$${p}_{n}^{i + 1} > {p}_{w}^{i + 1} + {p}_{c d}^{i + 1}$$

means that in the reservoir i+1, when the depth D of the reservoir is identical, the value of

$${p}_{n}^{i + 1}$$

is larger than the value of

$${p}_{w}^{i + 1} + {p}_{c d}^{i + 1} .$$

Otherwise, the following determination is conducted:

If the straight line lₚₙ and the straight line

$${l}_{p d}^{i + 1}$$

intersect in the reservoir i+1, the intersection point is the junction point of the non-wetting phase and the wetting phase; under such conditions, when

$${p}_{d}^{i + 2} \geq {p}_{d}^{i + 1} ,$$

where

$${p}_{d}^{i + 2}$$

is the displacement pressure of a reservoir i+2, then the reservoir i+2 is a pure wetting phase; i=i+1 is made; and the sizes of

$${p}_{d}^{i + 1}$$

and

$${p}_{d}^{i + 2}$$

are determined continuously until the condition is not satisfied or i+1=M.

In particular, when the straight line lₚₙ and the straight line

$${l}_{p d}^{i + 1}$$

intersect in the reservoir i+1, and a new continuous distribution region of the non-wetting phase n appears in the lower reservoir i+1+j(i+1+j∈{1,⋯, M}and j>0) of the reservoir i+1, judgment is made about whether the new continuous distribution region and the point A are in the same continuous distribution region; if so, a straight line

$${l}_{p d}^{i + 1 + j}$$

is established by the method in step S6 and is compared with the method in step S6; if not, a new pressure-depth curve needs to be established again in the reservoir i+1+j and processing is conducted according to step S2 and subsequent steps.

Step S7: for a point B in the same reservoir and in a region adjacent to a region where the point A is located, if a region where the point B is located and the region where the point A is located are in the same continuous distribution region of the non-wetting phase n, the calculation of the region where the point B is located is the same as the step of the region where the point A is located; if the region where the point B is located and the region where the point A is located are in different continuous distribution regions of the non-wetting phase n, repeating steps S3-S6 with the point B as a benchmark.

In some embodiments, the reservoir is not only longitudinally heterogeneous seriously, but also transversely heterogeneous seriously. Therefore, a transversely heterogeneous reservoir is divided into M layers, and each reservoir is divided into N regions transversely. In this way, a full three-dimensional heterogeneous reservoir is divided. Subsequently, the reservoir is calculated by the methods in steps S2-S7.

In conclusion, relative to the traditional method, the method of the present invention can obtain the static equilibrium distribution of fluid in the reservoirs without the need of an oil-water interface or gas-water interface, and can also process transverse and vertical heterogeneous oil and gas reservoirs. The present invention proves that oil-water or gas-water can coexist in the reservoirs even if an oil layer or gas layer is not communicated with a water layer. The present invention has important guiding significance for reserve calculation of the oil and gas reservoirs, driving energy evaluation, liquid production profile and numerical simulation initialization of the oil and gas reservoirs.

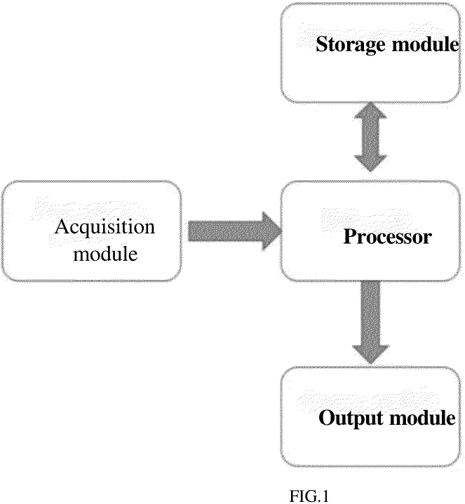

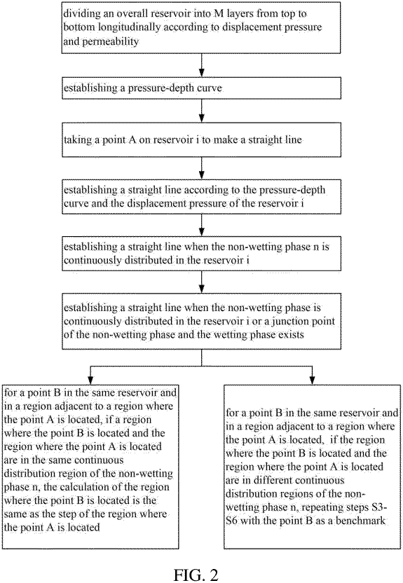

As shown in FIG. 1, a device for studying fluid equilibrium distribution in heterogeneous oil and gas reservoirs comprises:
a processor, and
an acquisition module, used for acquiring initial data for studying fluid equilibrium distribution in heterogeneous oil and gas reservoirs;
an output module, used for outputting calculation results;
a memory, wherein the memory stores programs that can be run on the processor for studying the fluid equilibrium distribution in heterogeneous oil and gas reservoirs, and the programs for studying the fluid equilibrium distribution in heterogeneous oil and gas reservoirs realize the steps of the above method when executed by the processor.

A computer readable storage medium is provided. The computer readable storage medium stores program codes that can be executed by the processor; the computer readable storage medium comprises a plurality of instructions, and the plurality of instructions are configured to enable the processor to execute the above method for studying fluid equilibrium distribution in heterogeneous oil and gas reservoirs.

The above embodiments are only part of embodiments of the present invention and are used for describing basic principles, implementation purposes and detailed flows of the present invention, not intended to limit the service scope of the present invention. Any amendment, equivalent change and modification made to the above implementation solutions according to the technical essence of the present invention shall belong to the scope of the technical solution of the present invention. The present invention is disclosed above through preferred embodiments. However, those skilled in the art shall understand that the embodiments are only used for describing the present invention and shall not be interpreted as limitations to the scope of the present invention. Further improvement on the present invention shall also be considered to belong to the protection scope of the present invention without departing from the principle of the present invention.

1. A device for studying fluid equilibrium distribution in heterogeneous oil and gas reservoirs, comprising a processor executing the following steps:
step S1: dividing an overall reservoir into M layers from top to bottom longitudinally according to displacement pressure and permeability;
step S2: establishing a pressure-depth curve l_{pw} : p_{w}(D)=p_{wref}+ρ_{w}g(D-D_{ref}) according to a pressure-depth relationship of formation water in surrounding rock, where p_{w} is density of a wetting phase of the surrounding rock; g is gravity acceleration; D is reservoir depth; p_{wref} is water phase pressure of a reference point; and D_{ref}is depth of the reference point;
step S3: taking a point A on reservoir i, where i∈ {1,...,M}; making a straight line lₚₙ : pₙ(D)=PnA+ pₙg(D - D_{A}) with both ends passing through a rock layer i through the point, where pₙ is density of a non-wetting phase n in surrounding rock; D_{A} is the depth of the point A; and p_{nA} is pressure of the point A;
step S4: establishing a straight line
$${l}_{p d}^{i} : \left({P}_{W} + {P}_{c d}^{i}\right) ∼ D$$
according to the pressure-depth curve and the displacement pressure of the reservoir i, where
$${P}_{{}^{c d}}^{i}$$
is the displacement pressure of the reservoir i, and judging the distribution of the non-wetting phase n in the reservoir i according to whether the straight line lₚₙ and the straight line
$${l}_{p d}^{i}$$
intersect in the reservoir i and the pressure size:
when the straight line lₚₙ and the straight line
$${l}_{p d}^{i}$$
intersect in the reservoir i, an pn intersection point therebetween is a junction point of the non-wetting phase n and the wetting phase;
when the straight line lₚₙ and the straight line
$${l}_{p d}^{i}$$
do not intersect in the reservoir i, and
$${p}_{n}^{i} > {p}_{w}^{i} + {p}_{c d}^{i} ,$$
, the non-wetting phase n is continuously distributed in the reservoir i, where
$${p}_{n}^{i}$$
is the value of the straight line
$${l}_{p d}^{i}$$
in the reservoir i; and
$${p}_{w}^{i}$$
is the value of the straight line l_{pw} in the reservoir i;
when the straight line lₚₙ and the straight line lₚₙ do not intersect in the reservoir i, and
$${p}_{n}^{i} < {p}_{w}^{i} + {p}_{c d}^{i} ,$$
the continuously distributed non-wetting phase n does not exist in the reservoir i;
step S5: when the non-wetting phase n is continuously distributed in the reservoir i, establishing a straight line
$${l}_{p d}^{i - 1} : \left[{p}_{w} \left(D\right) + {p}_{c d}^{i - 1}\right] ∼ D ,$$
where
$${p}_{c d}^{i - 1}$$
is the displacement pressure in a reservoir i-1 and the reservoir i-1 is located above the reservoir i, and according to whether the straight line 1ₚₙ and the straight line
$${l}_{p d}^{i - 1}$$
intersect in the reservoir i-1 and the pressure size, judging the distribution of the non-wetting phase n in the reservoir i-1 :
when the straight line lₚₙ and the straight line
$${l}_{p d}^{i - 1}$$
do not intersect in the reservoir i-1, and
$${p}_{n}^{i - 1} > {p}_{w}^{i - 1} + {p}_{c d}^{i - 1} ,$$
where
$${p}_{n}^{i - 1}$$
is the value of the straight line lₚₙ in the reservoir i-1 and
$${p}_{w}^{i - 1}$$
is the value of the straight line l_{pw} in the reservoir i - 1 , the non-wetting phase n is continuously distributed in the reservoir i - 1 and i = i -1 is made; step S5 is repeated; otherwise, the continuously distributed non-wetting phase n does not exist in the reservoir i - 1 ;
step S6: when the non-wetting phase is continuously distributed in the reservoir i or a junction point of the non-wetting phase and the wetting phase exists, establishing a straight line
$${l}_{p d}^{i + 1} : \left[{p}_{w} \left(D\right) + {p}_{c d}^{i + 1}\right] ∼ D ,$$
where
$${p}_{c d}^{i + 1}$$
is the displacement pressure in a reservoir i + 1 and the reservoir i + 1 is located below the reservoir i, and according to whether the straight line lₚₙ and the straight line
$${l}_{p d}^{i + 1}$$
intersect in the reservoir i + 1 and the pressure size, judging the distribution of the non-wetting phase n in the reservoir i + 1 :
when the straight line lₚₙ and the straight line
$${l}_{p d}^{i + 1}$$
do not intersect in the reservoir i + 1 , and
$${p}_{n}^{i + 1} > {p}_{w}^{i + 1} + {p}_{d}^{i + 1} ,$$
the non-wetting phase n is continuously distributed in the reservoir i + 1 , and i = i + 1 is made; step S6 is repeated; otherwise, the following determination is conducted:
if the straight line lₚₙ and the straight line
$${l}_{p d}^{i + 1}$$
intersect in the reservoir i + 1 , the intersection point is the junction point of the non-wetting phase and the wetting phase; under such conditions, when
$${p}_{d}^{i + 2} \geq {p}_{d}^{i + 1} , \text{where} {p}_{d}^{i + 2}$$
is the displacement pressure of a reservoir i + 2 , then the reservoir i + 2 is a pure wetting phase; i = i + 1 is made; and the sizes of
$${p}_{d}^{i + 1} \text{and} {p}_{d}^{i + 2}$$
are determined continuously until the condition is not satisfied or i + 1 M;
step S7: for a point B in the same reservoir and in a region adjacent to a region where the point A is located, if a region where the point B is located and the region where the point A is located are in the same continuous distribution region of the non-wetting phase n, the calculation of the region where the point B is located is the same as the step of the region where the point A is located; if the region where the point B is located and the region where the point A is located are in different continuous distribution regions of the non-wetting phase n, repeating steps S3-S6 with the point B as a benchmark, thereby obtaining the static equilibrium distribution of fluid in the reservoirs.

2. The device according to claim 1, wherein the step S1 further comprises: after the reservoir is divided into M layers, dividing each reservoir into N regions by considering the displacement pressure and permeability of the reservoir in a transverse direction, then selecting a point from each layer and conducting calculation respectively according to steps S2-S7.

3. The device according to claim 1, wherein in step S5, when the continuously distributed non-wetting phase n does not exist in the reservoir i-1, if the continuous distribution region of the non-wetting phase n appears in an upper reservoir i-l-m of the reservoir i-1,
i - 1 -m∈ {1, ⋯,M}; judgment is made about whether the continuous distribution region of the fluid which appears in the reservoir i-l-m and the point A are in the same continuous distribution region; if so, a straight line is established by the method in step S5 and is calculated together with the straight line lₚₙ by the method in step S5; if not, a new pressure-depth curve needs to be established and calculation is conducted according to the method in step S2-S7.

4. The device according to claim 1, wherein in step S6, when the straight line lₚₙ and the straight line
$${l}_{p d}^{i + 1}$$
intersect in the reservoir i+1, and the continuous distribution region of the non-wetting phase n exists in the reservoir i + 1 = j, wherein i +1 + j∈{1,⋯, M}, j >0, judgment is made about whether the continuous distribution region of the non-wetting phase n which appears in the reservoir i + 1 + j and the point A are in the same continuous distribution region; if so, a straight line
$${l}_{p d}^{i + 1 + j}$$
is established by the method in step S6 and calculation is conducted by the method in step S6; if not, a new pressure-depth curve needs to be established and calculation is conducted according to the method in step S2-S7.

5. The device according to claim 1, wherein in step S3, the reservoir i is a main production layer of the overall reservoir.

6. The device according to claim 1, wherein the wetting phase is a water phase and the non-wetting phase is an oil phase or gas phase.

7. The device according to claim 1, further comprising: a
an acquisition module, used for acquiring initial data for studying fluid equilibrium distribution in heterogeneous oil and gas reservoirs;
a storage module, wherein a memory stores programs that can be run on the processor for studying the fluid equilibrium distribution in heterogeneous oil and gas reservoirs, and the programs for studying the fluid equilibrium distribution in heterogeneous oil and gas reservoirs realize the steps S1-S7 when executed by the processor; and
an output module, used for outputting calculation results.

8. A non-transitory tangible computer readable storage medium, storing program codes that can be executed by the processor, wherein the computer readable storage medium comprises a plurality of instructions, and the plurality of instructions are configured to enable the processor to execute the steps S1-S7 for studying fluid equilibrium distribution in heterogeneous oil and gas reservoirs of claim 1.
